(19) United States
(12) Patent Application Publication
(10) Pub. No.: US 2026/0264032 A1
(43) Pub. Date: Sep. 10, 2026

(54) PERSONAL SOLUTION-MIXING DEVICE FOR CONSUMER USE

(71) Applicant: Galit LORBER, Savion (IL)

(72) Inventor: Galit LORBER, Savion (IL)

(21) Appl. No.: 19/162,935

(22) PCT Filed: Jun. 29, 2023
(86) PCT No.: PCT/IL2023/050677

§ 371 Date: Sep. 7, 2025

Related U.S. Application Data
(60) Provisional application No. 63/450,813, filed on Mar. 8, 2023.

(51) Int. Cl. B01F 35/71; A45D 44/00; B01F 23/40; B01F 23/43; B01F 35/11; B01F 35/21; B01F 35/22; B01F 35/75; B01F 35/90; B01F 35/95; B01F 101/00

(52) U.S. Cl. CPC B01F 35/7132; A45D 44/005; B01F 23/43; B01F 23/483; B01F 35/11; B01F 35/2112; B01F 35/2206; B01F 35/2207; B01F 35/7544; B01F 35/95; B01F 2035/99; B01F 2101/4505

(57) ABSTRACT

A system and methods are provided for preparing a mixed solution, the system includes: a mixing tank with a motorized mixing rod and a heating element, and 2) a capsule receptacle to receive a capsule of a concentrate. The capsule receptacle has a capsule inlet for receiving water into the capsule and a capsule outlet for releasing the water with the concentrate to the mixing tank. A controller is configured to operate the mixing rod and the heating element to generate a mixed solution from the water and the concentrate, according to a mixing profile. An output pump is operated to pump the mixed solution from the mixing tank to a detachable bottle.

### FIELD OF THE INVENTION

The present invention relates to the field of hygiene and cleaning. More specifically, the present invention relates to systems and methods for preparing liquid soap, shampoo, and other hygiene lotions and cleaning materials from a concentrate.

### BACKGROUND

Shampoos, conditioners and other personal care and household cleaning products are generally purchased as finished products in a single-use package. Many of these finished products consist primarily of water, in some cases over 90%, in addition to a relatively small percentage of active ingredients. As such, consumers pay a significant cost for water, including the cost of transporting the water from factories to their homes, not to mention the environmental cost of emissions associated with the transport of large quantities of such products, as well as storage requirements. Additionally, consumers also pay for single-use packaging materials, usually plastics, such as bottles, caps and dispensing systems like trigger sprayers and pumps, all of which typically end up in landfills. The majority of all plastics never biodegrades while their manufacturing processes cause severe environmental damage.

Flexible packaging of finished products may have a lower cost and a smaller environmental footprint compared to rigid packaging, but they still contain primarily water and therefore take up a great deal of space in transit and storage in the retail environment and in consumer homes. Moreover, the finished products limit a consumer to a particular set of mass-produced options, with no personalization or customization options. Consumer choice is further limited by a given retailer's stock.

U.S. Pat. No. 9,731,254 describes a method and system of preparing a solution from a concentrate, including a production unit that has a controller, a pod dock, and a container dock. The pod dock is for a concentrate pod, and the container dock is for a mixing container. A base fluid is injected into the mixing container and concentrate from the concentrate pod is pushed or squeezed into the mixing container, to be mixed with the base fluid. The mixing container has a mixing impeller, which rotates in order to mix the concentrate with the base fluid. US 2019/0381465 also describes a device for mixing fluids, primarily for food or drinks.

WO 2020/105053 similarly describes a device for mixing fluids, having multiple capsules such that ratios of solutions can be changed. According to the description, the device allows one-time preparation or multiple preparations per capsule.

Thus, a need exists for a way to provide cleaning materials to consumer that requires low storage and reduces environmental foot print, while enabling personalization uses, as well as devices and methods therefor.

### SUMMARY OF THE INVENTION

The present invention provides a mixing system and methods for creating a mixed liquid solution, such as shampoo, by mixing a solvent, such as water, with a solute, such as a shampoo concentrate that includes a shampoo-compatible surfactant and other active ingredients.

The present invention provides a system for preparing a mixed solution, comprising: a mixing tank, comprising a motorized mixing rod and a heating element; a capsule receptacle configured to receive a capsule of a concentrate, wherein the capsule receptacle comprises a capsule inlet conveying water to the capsule and a capsule outlet conveying the water with the concentrate from the capsule to the mixing tank; an output pump configured to dispense the mixed solution from the mixing tank to a designated reusable detachable bottle; and a controller configured to operate the mixing rod and the heating element to generate the mixed solution from the water and the concentrate according to a mixing profile.

The present invention further provides a method for preparing a mixed detergent solution using a mixing system that includes a mixing tank having a motorized mixing rod and a heater, a capsule receptacle configured to receive a capsule of concentrate, an input pump, an output pump, and a controller having memory with instructions that when executed implement the following steps: (a) receiving a capsule code from a code reader of the capsule receptacle and responsively determining a mixing profile; (b) receiving a signal from a level sensor of a water tank indicating that there is sufficient water to prepare a mixed solution; (c) responsively operating the input pump, pumping water to a capsule in the capsule receptacle and from the capsule receptacle to the mixing tank; (d) subsequently operating the mixing rod and the heater according to the mixing profile to generate the mixed solution, wherein the mixing profile specifies a duration, temperature and speed of mixing; (e) subsequently determining that a bottle is in positioned to receive the mixed solution; and (f) responsively operating the output pump to pump the mixed solution to the detachable bottle.

### BRIEF DESCRIPTION OF THE DRAWINGS

In the accompanying drawings:

FIG. 1 is a schematic illustration of a solution-mixing system for consumer use, according to embodiments of the present invention;

FIG. 2 is a schematic illustration of detachable elements of the solution-mixing system for consumer use, according to embodiments of the present invention;

FIG. 3 is a schematic cut-away illustration showing internal elements of the solution-mixing system for consumer use, according to embodiments of the present invention;

FIG. 4 is a block diagram indicating fluid flow between elements of the solution-mixing system, according to embodiments of the present invention;

FIG. 5 is a block diagram of the solution-mixing system, indicating power and signal communications between elements, according to embodiments of the present invention; and

FIG. 6 is a flow diagram of a process executed by a controller of the solution-mixing system, according to embodiments of the present invention.

### DETAILED DESCRIPTION

Today, cleaning products, such as household cleaning and personal care products are provided ready-to-use in a single-use package. Since such products are comprised essentially of water, the meaning is that the manufacturer is required to transport and store large quantities of water which is both expensive and space-consuming. Moreover, the end costumer needs to pay for such expenses. In addition, transportation increases the release of greenhouse gas and raises carbon footprint.

Another aspect relates to the current ways of extraction, production, consumption, reprocessing and post consumption of large quantities of plastic. As most plastics never biodegrade, their break down overtime into microplastic not only affects marine life and ecosystems but also pollutes water resources which penetrate the food chain and cause both long-term environmental damage and health problems.

Accordingly, the present invention is aimed at reducing the above and other issues by providing cleaning-materials concentrates and systems of using same for preparing a mixed solution in a consumer setting, such as a home, hotels, and other institutions, so as to avoid the economic and environmental burden of transporting finished goods that are primarily water, while also avoiding the waste of plastic packaging. In addition, the present system and method provide consumers with flexibility to create custom hygienic products, with a wide range of properties to suit personal preferences, such as customized shampoo and conditioning fragrances, nutrients and other properties.

The present invention thus provides a system for consumer liquid product manufacture that has a mixing tank having a motor-driven mixing rod and a heating element, as well as a capsule receptacle (i.e., a housing) configured to receive a capsule of a concentrate. The capsule receptacle has a capsule inlet, for conveying water to the capsule, and a capsule outlet, for conveying the water with the concentrate from the capsule to the mixing tank. A controller of the system is configured to operate the mixing rod and the heating element. An output pump of the system is operated to convey the mixed solution from the mixing tank to a detachable bottle (i.e., an output container). Operation of the mixing rod and the heating element according to a mixing profile produces the desired mixed solution.

Accordingly, in a first aspect, the present invention provides a system for preparing a mixed solution, comprising: a mixing tank, comprising a motorized mixing rod and at least one heating element; a capsule receptacle configured to receive a capsule of a concentrate, wherein the capsule receptacle comprises a capsule inlet conveying water to the capsule and a capsule outlet conveying the water with the concentrate from the capsule to the mixing tank; an output pump configured to dispense the mixed solution from the mixing tank to a designated reusable detachable bottle; and a controller configured to operate the mixing rod and the heating element to generate the mixed solution from the water and the concentrate according to a mixing profile.

In certain embodiments of the system of the invention, the heating element is located along the water flow path before reaching the capsule receptacle to thereby provide hot water directly to the capsule and further into the mixing tank.

In certain embodiments of the system of the invention, the heating element is: built into the mixing rod; located inside the mixing tank; located around the mixing tank, or any combination thereof. In specific such embodiments, the system comprises a heating element built into the mixing rod as well as a heating element located around the mixing tank. In alternative specific embodiments, the system comprises a heating element built into the mixing rod as well as a heating element located inside the mixing tank. In further alternative specific embodiments, the system comprises a heating element located around the mixing tank as well as a heating element located inside the mixing tank. In yet further alternative specific embodiments, the system comprises a heating element built into the mixing rod as well as heat elements located around the mixing tank as well as inside the mixing tank.

In certain embodiments, the system according to any of the embodiments above further comprises the designated reusable detachable bottle.

In certain embodiments, the system according to any of the embodiments above further comprises a platform comprising a magnetic contact to secure said reusable bottle while the mixing solution is dispensed.

In certain embodiments of the system according to any of the embodiments above, the capsule receptacle comprises a code reader configured to transmit to the controller a signal indicative of a code of the capsule, and wherein the controller is configured to determine the mixing profile according to the capsule code and to: (i) set the mixing duration according to the mixing profile; and/or (ii) operate the heating element and the mixing rod according to the mixing profile.

In certain embodiments, the system according to any of the embodiments above further comprises: (1) a water tank; and (2) an input pump configured to pump the water from the water tank through the capsule inlet to the capsule, forcing the water and the concentrate from the capsule through the capsule outlet to the mixing tank. In specific embodiments thereof, the water tank comprises a level sensor, and wherein the controller is further configured to operate the input pump only after receiving a signal from the level sensor indicating a water level and determining that the water level satisfies the mixing profile. In further specific embodiments, the controller is further configured to determine that the water level does not satisfy the mixing profile and to issue an alert at a user interface.

In certain embodiments of the system according to any of the embodiments above, the mixing tank comprises a level sensor, wherein the controller is further configured to operate the input pump until a mixing tank level satisfying the mixing profile is reached.

In certain embodiments, the system according to any of the embodiments above further comprises an additive tank and an additive tank pump, and wherein the controller is further configured to operate the additive tank pump to inject additive into the mixing tank according to the mixing profile.

In certain embodiments of the system according to any of the embodiments above, the main body comprises a platform-contact configured to detect the presence of said reusable bottle and wherein the controller is further configured to receive a bottle's presence signal from the platform-contact and responsively to operate the output pump to convey the mixed solution only when there is a bottle presence signal after a mixing duration elapses as specified by the mixing profile.

In certain embodiments, the system according to any of the embodiments above further comprises a bottle platform and said detachable bottle, wherein the platform has a protruding, magnetic contact and the detachable bottle has a cavity configured to couple magnetically with the platform-contact. In certain embodiments, both the magnet and the signal allow operation of the system. For instance, the operation may be comprised of a two-step activation for security and identification. Alternatively, it may be a single-step operation.

In certain embodiments, the system according to any of the embodiments above further comprise a rinse capsule, which is optionally reusable, designed to be inserted in the capsule receptacle and responsively to operate the input pump to provide rinse water to the mixing tank and to operate the output pump to complete a rinse process. In further or alternative embodiments, the system further includes a dedicated rinse-container or other special cleaning bottle or tube for collecting the rinsing water.

In a second aspect, the present invention provides a method for preparing a mixed detergent solution using a mixing system that includes a mixing tank having a motorized mixing rod and a heater, a capsule receptacle configured to receive a capsule of concentrate, an input pump, an output pump, and a controller having memory with instructions that when executed implement the following steps: (a) receiving a capsule code from a code reader of the capsule receptacle and responsively determining a mixing profile; (b) receiving a signal from a level sensor of a water tank indicating that there is sufficient water to prepare a mixed solution; (c) responsively operating the input pump, pumping water to a capsule in the capsule receptacle and from the capsule receptacle to the mixing tank; (d) subsequently operating the mixing rod and the heater according to the mixing profile to generate the mixed solution, wherein the mixing profile specifies a duration, temperature and speed of mixing; (e) subsequently determining that a bottle is in position to receive the mixed solution; and (f) responsively operating the output pump to pump the mixed solution to the detachable bottle.

In certain embodiments, the above method further comprises any of the following steps: (i) placing the detachable bottle and receiving a positive-position indication, e.g., using a dedicated sensor or barcode-reader designed to identify a magnet or barcode (or near field communication means (NFC)) on the bottle; (ii) inserting a capsule holding a concentrate into the capsule receptacle, wherein the capsule may have an indicator readable by a suitable reader in the capsule receptacle that determines its content and the required mixing protocol therefor; (iii) opening the capsule; (iv) determining a suitable mixing profile; and (v) a rinsing step, or any combination thereof.

In a third aspect, the present invention provides a method for preparing a mixed detergent solution using a mixing system that includes a mixing tank having a motorized mixing rod and a heater, a capsule receptacle configured to receive a capsule of concentrate, an input pump, an output pump, and a controller having memory with instructions that when executed implement the following steps: (a) placing the detachable bottle and receiving a positive-position indication and determining that a bottle is in positioned to receive the mixed solution; (b) inserting a capsule holding a concentrate into the capsule receptacle; (c) receiving a capsule code from a code reader of the capsule receptacle and responsively determining a mixing profile; (d) receiving a signal from a level sensor of a water tank indicating that there is sufficient water to prepare a mixed solution; (e) responsively operating the input pump, pumping water to a capsule in the capsule receptacle and from the capsule receptacle to the mixing tank; (f) subsequently operating the mixing rod and the heater according to the mixing profile to generate the mixed solution, wherein the mixing profile specifies a duration, temperature and speed of mixing; and (g) responsively operating the output pump to pump the mixed solution to the detachable bottle.

In certain embodiments, the above method further comprises any of the following steps: (i) inserting a capsule holding a concentrate into the capsule receptacle, wherein the capsule may have an indicator readable by a suitable reader in the capsule receptacle that determines its content and the required mixing protocol therefor; (ii) opening the capsule; (iii) determining a suitable mixing profile; and (iv) a rinsing step, or any combination thereof.

In certain embodiments, the step of opening the capsule is carried out using any suitable way, such as by: (i) manually removing a cover before insertion thereon into the capsule receptacle; (ii) using a dissolving cover or body, which is designed to dissolve when brought in contact with water (or other solvent used); (iii) piercing the capsule-either manually or using a dedicated piercer within the capsule receptacle; (iv) unscrewing a cap therefrom; (v) breaking the capsule before insertion into the capsule receptacle or using a dedicated device within the capsule receptacle that breaks it, e.g., using pressure; and (vi) heat melting, in which case the capsule receptacle further includes a heater for heating and melting the capsule's coat, or the water that is passed to the capsule is preheated as mentioned above, or any combination thereof.

In certain embodiments of any of the methods above, the controller is further configured to receive a rinse code of a rinse capsule inserted in the capsule receptacle and responsively to operate the input pump to provide rinse water to the mixing tank and to operate the output pump to complete a rinse process. In specific embodiments thereof, the rinse capsule is a reusable cleaning capsule. In further or alternative embodiments, the method further comprises a step of placing or attaching to the system a rinse-container| or other special cleaning bottle or test tube for collecting the rinsing water.

For a better understanding of various embodiments of the invention and to show how the same may be carried into effect, reference will now be made, by way of example, to the accompanying drawings. Structural details of the invention are shown to provide a fundamental understanding of the invention, the description, taken with the drawings, making apparent to those skilled in the art how the several forms of the invention may be embodied in practice. Embodiments and/or limitations featured in the figures are chosen for convenience or clarity of presentation and are not meant to limit the scope of the invention.

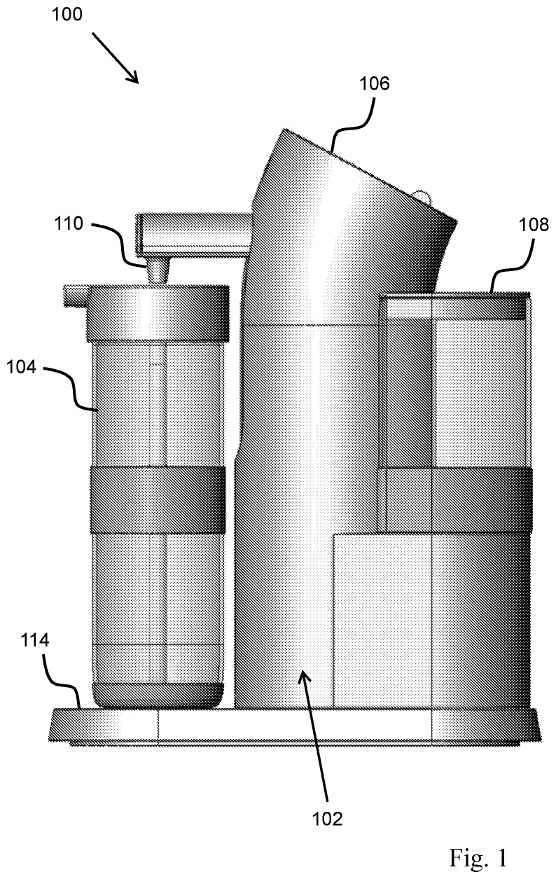

FIG. 1 is a schematic illustration of a solution-mixing system 100, according to embodiments of the present invention. The system includes a main body 102 and one or more detachable (typically reusable) bottles, such as a bottle 104. A mixed solution, generated in the main body typically as a homogenous mixture of a base liquid and solute, is dispensed (ready for use) into the bottle 104. The solute is referred to herein as a “concentrate” and is provided in the form of a capsule that is inserted into a capsule receptacle 106 of the main body 102.

The concentrate may be, e.g., a concentrated shampoo, including ingredients such as: anionic surfactants (such as alkyl sulfates), which serve as detergents and foaming agents; additional surfactants to improve foaming properties; additives for thickness, stability, conditioning, color, and fragrance; and ingredients for specific issues, such as dandruff, dry and oily hair. The concentrate may be in the form of a powder or liquid.

The base liquid (i.e., the solvent) is typically water, though it is to be understood that other liquids may be used, depending on the application. The base liquid is typically provided from a refillable tank 108, also referred to herein as a “water tank,” which is typically detachable. Alternatively, water may be provided from an external connection, such as a water faucet, typically with a filter to purify the water and/or to remove particles therefrom to prevent clogging of the system or any other type of drinking water.

As shown, the mixed solution is dispensed from nozzle 110 into the bottle 104, the bottle being positioned during filling on a platform 114 of the main body 102 of the system 100.

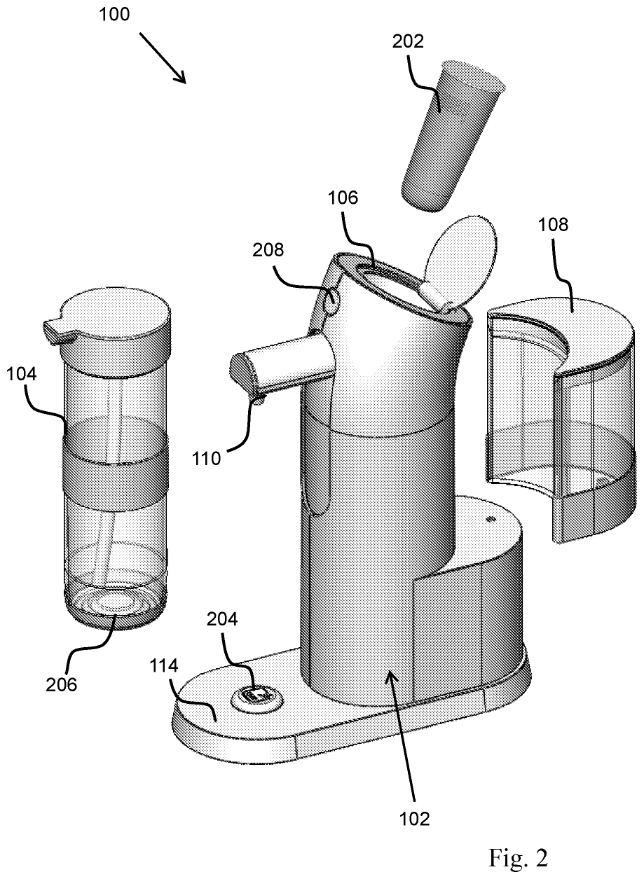

FIG. 2 is a schematic illustration showing both the bottle 104 and the water tank 108 when detached from the main body 102 of the system 100. In addition, the figure shows an exemplary design of a concentrate capsule 202, which is configured to be inserted into the capsule receptacle 106. The capsule used by the system is typically around 20% or less the size of a packaged goods that contains the same amount of a mixed solution that can be generated from the capsule. Consequently, using the system 100 of the invention to create mixed solutions is much more economical and far less of an environmental burden than buying packaged goods that contain the same solutions.

A platform-contact 204, which is part of the main body platform 114, may be provided to hold the bottle 104 in place below the nozzle 110 when the bottle is filled. The platform-contact 204 may be coupled with a base of the bottle 104, which may have a complementary bottle base contact 206. For example, the platform-contact 204 may have a protrusion that fits a cavity of the bottle base contact 206. In addition, the platform-contact 204 may be magnetic, while the bottle base contact may be metallic and/or magnetic (or vise-versa). The platform-contact 204 may also be configured as a mechanical, visual, and/or electrical presence sensor to detect presence of the bottle 104, for example by incorporation of an RFID sensor (or other near field communication means) that may detect an RFID of the bottle base contact, as described further hereinbelow. Notably, such sensor or tag may be positioned at any location on the bottle 104, with a corresponding sensor at a suitable location in the main body 102. For instance, a metal or magnet may be used to close an electric cycle, e.g., for secure use and other commercial reasons, such as prevent unintentional spillage of the mixed product.

The main body 102 may also include a user interface 208, such as a touch screen and/or fingerprint (touch) recognition which may be a LED light (as shown) or a display to receive input from a user and to display notifications and alerts, as described further hereinbelow. Additionally, or alternatively, the main body 102 may include a speaker to provide one or more audio alerts. Additionally, or alternatively, the user interface may include a wireless driver, such as a Bluetooth driver, for communicating with a remote device of a user, such as a mobile phone.

The main body 102 also typically has a power supply socket and power switch (not shown). Alternatively, or in addition, the main body 102 may have an internal power source, optionally rechargeable.

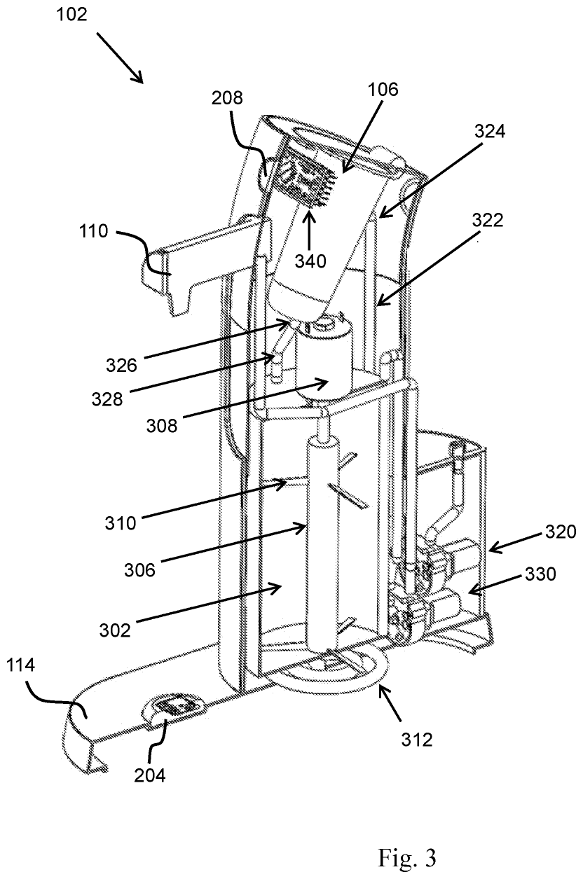

FIG. 3 is a schematic cut-away illustration showing internal elements of the main body 102 of the solution-mixing system 100 (the bottle 104 and the water tank 108 not shown). As shown, the main body 102 includes a mixing tank 302, in which the base liquid (e.g., water) and solute (e.g., concentrate) are mixed. The mixing tank 302 includes a mixer, such as a mixing rod 306, which is driven by a motor 308. The mixing rod 306 typically includes impellers 310. The mixing tank 302 also includes a heater 312, as well as a temperature sensor (not shown), such as a thermocouple, designed to bring the mixed solutions to a desired temperature that facilitates mixing. In certain embodiments, an additional (vertical) heater may be positioned inside the mixing rod itself (not shown). Alternatively, the heater 312 within the mixing tank 302 is the heater inside the mixing rod. In certain embodiments, the temperature in the mixing tank 302 is in the range of from about 35° C. to about 70° C.

To mix a solution, an input pump 320 pumps water (or other base liquid) from the water tank 108 through an input tube 322 into a capsule containing concentrate 202 positioned in the capsule receptacle 106. The water enters the capsule at a capsule inlet 324 of the capsule receptacle. The water flushes the concentrate from the capsule, such that the water and the concentrate exit the capsule at a capsule outlet 326 of the capsule receptacle. Optionally, the water flows at a pressure higher than ambient pressure to improve washing all the concentrate out of the capsule. The water and the concentrate flow through a capsule outlet tube 328 to enter the mixing tank 302, where they are mixed and heated to become a mixed (typically homogenous) solution. The capsule 202 may be opened either by the user prior to its insertion into the capsule receptacle 106 or by a dedicated capsule-piercer within the capsule receptacle 106.

In the mixing tank, additional additives may also be added to the solution, from one or more additional additive tanks (not shown) or via a dedicated opening/passageway enabling addition of material directly into the mixing tank 302 or into the capsule receptacle 106, to provide further customization of the solution, as described further hereinbelow. Notably, the capsule itself might contain such additives or comprise a separate chamber(s) holding such additives. The homogenous, mixed solution is then pumped by an output pump 330 to the nozzle 110 to be dispensed into the detachable bottle 104.

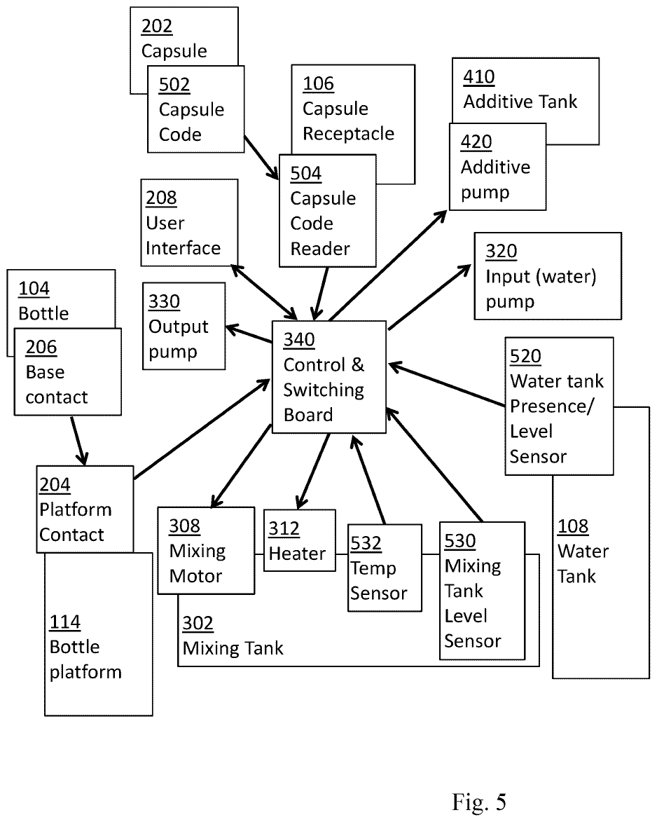

A controller 340 (shown on a circuit board, also referred to herein as a “switching board”) typically is provided to operate other elements of the system as described herein. That is, the controller, which may be any processor known in the art, has associated memory that is programmed to include instructions, which, when executed, perform steps described herein. For example, the controller 340 typically controls operation of the pumps, mixing tank motor, and heater, in response to receiving signals from sensors, such as temperature sensors and tank level sensors. The controller may also receive and provide signals to the user interface 208. The contact 204 of the main body platform 114 may also be configured to sense presence of a bottle 104, for example mechanically, visually, or by RFID, as mentioned above. The contact 204 may then signal the controller 340 as to the presence of a bottle on the main body platform 114. As described further hereinbelow, the controller 340 may also receive a signal with a capsule code (also referred to herein as a capsule identification or ID) from a code reader of the capsule receptacle, as described further hereinbelow with respect to FIG. 5.

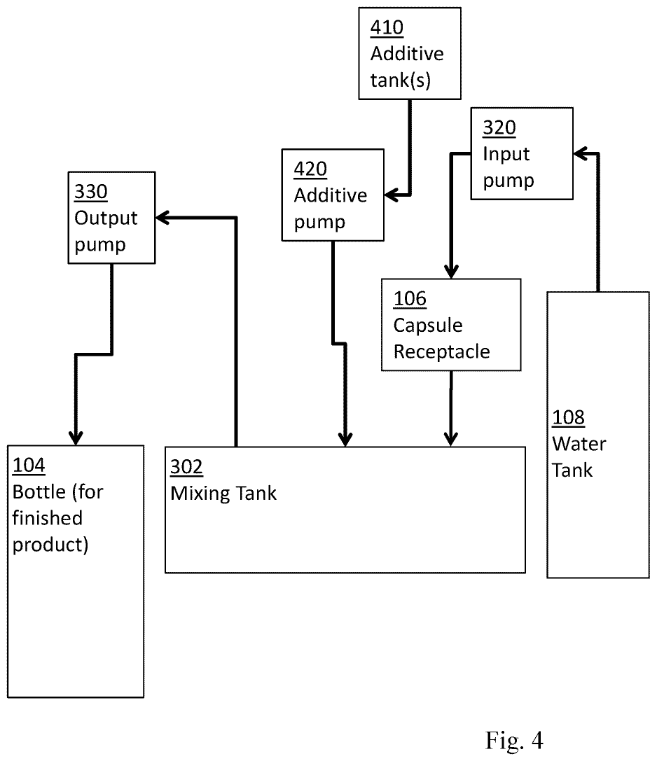

FIG. 4 is a block diagram indicating fluid flow between elements of the solution-mixing system 100. Initially the input pump 320 pumps water from the water tank 108 into a concentrate capsule positioned in the capsule receptacle 106. The water flushes the concentrate from the capsule, such that the water together with the concentrate flow from the capsule receptacle to the mixing tank 302. Additives, such as fragrances and conditioners, may also be provided in one or more additive tanks 410, from which they are also moved to the mixing tank 302. After mixing, the mixed solution, that is, the finished product, is then pumped by an output pump to the bottle 104.

FIG. 5 is a block diagram indicating power and signal communications between the controller 340 and other elements of the solution-mixing system 100. As described above, the capsule may include a capsule code 502, which is a discernable external identifier, such as a bar code or QR code, or other forms of automated ID known in the art. The receptacle 106 may include a complementary code reader 504, which reads the code and transmits the code to the controller 340.

The code on a capsule identifies the type (i.e., the “ID”) of the concentrate contained in the capsule 202 and determines the intended mixed solution to be generated from the specific concentrate. Proper generation of the mixed solution requires that a specific mixing profile be employed during mixing. The mixing profile specifies the temperature, mixing speed (i.e., mixing rod rotation speed), mixing duration, and water quantity used during mixing, as well as any additional, relevant properties, which may include addition of additives if required. A correlation between capsule codes and profiles is typically stored in memory of the controller 340, such that the controller determines the mixing profile according to the capsule code received from the code reader. The system 100 may also include wired and/or wireless communication (not shown) for updating the stored profiles of the controller 340. Alternatively, or additionally to receiving the capsule code from the code reader, the controller 340 may receive user input, from the user interface 208, that sets or modifies the mixing profile. For example, a user selection may be entered that specifies a given fragrance additive to add during mixing.

In addition to receiving input from the code reader 504, the controller may also receive input from the platform-contact 204 indicating presence of a bottle 104 (having a base contact 206) to which the mixed solution is dispensed. As such, the lack of a suitable bottle 104 causes the system 100 to stop working or prevent pumping the ready solution outside the mixing tank 302.

Further input signals may be received from level/presence sensors indicative of water and mixed solution levels. For example, a water level sensor 520 may be included in the water tank 108. A solution level sensor 530 may be included in the mixing tank 302.

During mixing, the controller 340 may also receive signals indicative of temperature from a temperature sensor 532 in the mixing tank 302.

As described above, in response to the various input signals, the controller 340 operates (e.g., provides power to) the input pump 320, pumping water to the capsule in the capsule receptacle 106, thereby forcing the flow of the water and the concentrate into the mixing tank 302. Subsequently the controller operates (e.g., provides power to) the output pump 330, pumping the mixed solution from the mixing tank to the bottle 104.

The controller further operates the mixing motor 308 at the speed indicated by the mixing profile and controls the heater 312 to maintain a target temperature of the mixed solution, as measured by the temperature sensor. During mixing, the controller 340 may also operate the additive pump 420, if provided, to deliver an additive from the additive tank 410, as described above.

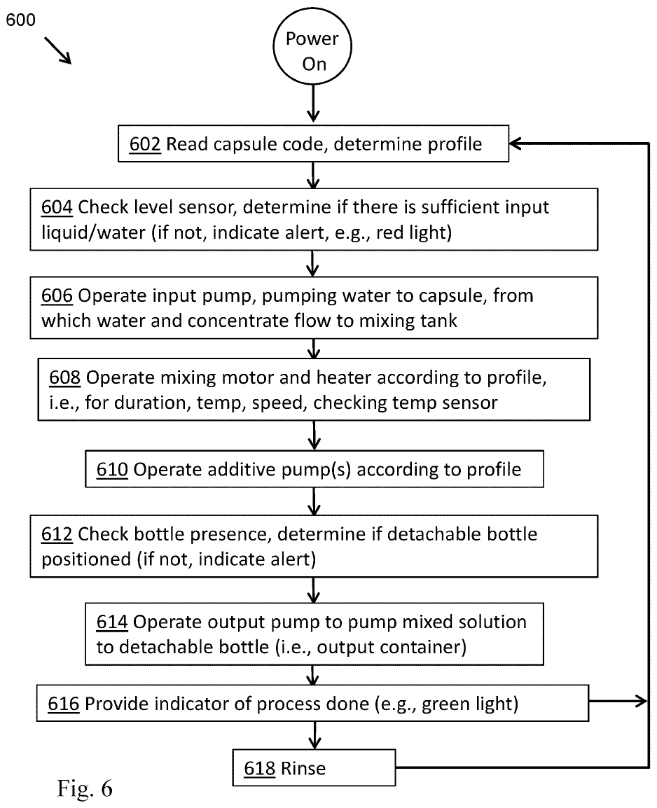

FIG. 6 is a flow diagram of a process 600 executed by the controller 340 of the solution-mixing system 100, according to embodiments of the present invention: After power-on (e.g., using a fingerprint), at a step 602, the controller determines the mixing profile, for example by receiving a signal indicating a capsule code or ID from the code reader of the capsule receptacle, or by receiving input from the user.

Next, at a step 604, the controller may receive a signal from a level sensor 520 of the water tank 108 indicating whether there is sufficient water to generate the mixed solution, as specified by the mixing profile. If there is not sufficient water, the controller may issue an alert to the user interface, such as a text message or a light or sound/voice indication. In alternative or added embodiments, a user's mobile device may be configured to provide such user interface, such that the alert may be communicated to the user's mobile device.

At a step 606, once there is sufficient water, the controller operates the input pump 320, pumping water to the capsule in the capsule receptacle 106, thereby forcing the concentrate and the water to flow from the capsule receptacle to the mixing tank 302. The controller may continue pumping water until a mixing tank level sensor 530 indicates that the desired quantity of water and concentrate is in the mixing tank. Alternatively, the controller may operate the input pump for a duration of time corresponding to the desired water quantity, or may operate the input pump until the water tank level sensor indicates that the correct amount of water has been transferred.

At a step 608, when the correct amount of water, mixed with the concentrate, is in the mixing tank, the controller operates the mixing motor 308 at the speed indicated by the mixing profile. In addition, the controller operates the heater 312 to attain the temperature (or sequence of temperatures) indicated by the mixing profile, the current temperature being read by the controller from a temperature sensor 532 in the mixing tank.

During mixing, the controller may also operate the additive pump 420 to deliver an additive from the additive tank 410, at a step 610.

At a step 612, after the specified duration of mixing is complete, the controller subsequently tests an input signal from the platform-contact 204 (e.g., an RFID sensor) of the platform 114 to confirm that a detachable bottle 104 is positioned to receive the mixed solution. Alternatively, the mixing does not commence until the system 100 identifies that a detachable bottle 104 is positioned in place. In certain embodiments, the system 100 starts working automatically once a detachable bottle 104 is positioned in place and a capsule is placed within the capsule receptacle 106. Alternatively, the user may need to press an activation button to commence the mixing process and/or after each step (e.g., to empty the capsule, to start mixing, to transfer the mix to the detachable bottle, and to wash the system after use). If the bottle is not in place, the controller may issue an alert that the mixing is complete (such as a blinking light, sound, or text message), thereby indicating to the user that a bottle must be positioned to receive the mixed solution.

At a step 614, when the bottle is in place, the controller operates the output pump to pump the mixed solution to the bottle. Next, at a step 616, the controller may provide an indication, such as a green light, to indicate that the bottle is full, that is, the process is complete and the bottle may be detached for subsequent use. The process may then be repeated for generating additional bottles of solution.

At given intervals, a rinse process may also be performed at a step 618 to prevent clogging of tubes of the system 100. For example, a special “rinse” capsule without concentrate may be provided that directs water from the receptacle inlet to the receptacle outlet. The code of the rinse capsule may indicate a “mixing” profile that is a rinse process. The controller may be configured to receive the rinse code of a rinse capsule inserted in the capsule receptacle and to operate the input pump to provide rinse water to the mixing tank and to operate the output pump to complete the rinse process. The mixing profile for the rinse process may also specify a speed of mixing and heating, to further improve the rinsing. Alternatively, a rinsing protocol may be activated without the use of a capsule, e.g., by closing the opening of the capsule receptacle 106 to prevent water from exiting the system via the capsule receptacle 106. In certain embodiments, after rinsing the system, the rinsing water is either poured into a sink, e.g., using a designated tube, or collected into a second bottle or container for disposal thereafter. Such second bottle or container may have similar features as the detachable bottle 104 as detailed herein.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

It is important to note that the methods/processes and/or systems/devices, etc., disclosed above, are not to be limited strictly to flowcharts and/or diagrams provided in the Drawings. For example, a method may include additional or fewer processes or steps in comparison to what is described in the figures. In addition, embodiments of the method are not necessarily limited to the chronological order as illustrated and described herein.

It is noted that terms such as “determining”, “identifying”, “detecting” and/or the like, may refer to operation(s) and/or process(es) of a computer, a computing platform, a computing system, or other electronic computing device(s), that manipulate and/or transform data represented as physical (e.g., electronic or optical signal) quantities within the computer's registers and/or memories into other data similarly represented as physical quantities within the computer's registers and/or memories or other information storage medium that may store instructions to perform operations and/or processes.

Terms used in the singular shall also include a plural scope, except where expressly otherwise stated or where the context otherwise requires.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made i.e. enabling all possible combinations of one or more of the specified options. Further, the use of the expression “and/or” may be used interchangeably with the expressions “at least one of the following”, “any one of the following” or “one or more of the following”, followed by a listing of the various options.

It is appreciated that certain features of the invention, which are, for clarity, described in the context of separate embodiments or example, may also be provided in combination in a single embodiment. Conversely, various features of the invention, which are, for brevity, described in the context of a single embodiment, example and/or option, may also be provided separately or in any suitable sub-combination or as suitable in any other described embodiment, example or option of the invention. Certain features described in the context of various embodiments, examples and/or optional implementation are not to be considered essential features of those embodiments, unless the embodiment, example and/or optional implementation is inoperative without those elements.

The number of elements shown in the figures should by no means be construed as limiting and is for illustrative purposes only.

1) A system for preparing a mixed solution, comprising:
a mixing tank, comprising a motorized mixing rod and heating element;
a capsule receptacle configured to receive a capsule of a concentrate, wherein the capsule receptacle comprises a capsule inlet conveying water to the capsule and a capsule outlet conveying the water with the concentrate from the capsule to the mixing tank;
an output pump configured to dispense the mixed solution from the mixing tank to a designated reusable detachable bottle; and
a controller configured to operate the mixing rod and the heating element to generate the mixed solution from the water and the concentrate according to a mixing profile.

2) The system of claim 1, further comprising said designated reusable detachable bottle.

3) The system of claim 1, wherein the system further comprises a platform comprising a magnetic contact to secure said reusable bottle while the mixing solution is dispensed.

4) The system of claim 1, wherein the capsule receptacle comprises a code reader configured to transmit to the controller a signal indicative of a code of the capsule, and wherein the controller is configured to determine the mixing profile according to the capsule code and to set the mixing duration according to the mixing profile.

5) The system of claim 1, wherein the capsule receptacle comprises a code reader configured to transmit to the controller a signal indicative of a code of the capsule, and wherein the controller is configured to determine the mixing profile according to the capsule code and to operate the heating element and the mixing rod according to the mixing profile.

6) The system of claim 4, wherein the code reader is a bar code or QR reader.

7) The system of claim 1, further comprising: 1) a water tank; and 2) an input pump configured to pump the water from the water tank through the capsule inlet to the capsule, forcing the water and the concentrate from the capsule through the capsule outlet to the mixing tank.

8) The system of claim 7, wherein the water tank comprises a level sensor, and wherein the controller is further configured to operate the input pump only after receiving a signal from the level sensor indicating a water level and determining that the water level satisfies the mixing profile.

9) The system of claim 8, wherein the controller is further configured to determine that the water level does not satisfy the mixing profile and to issue an alert at a user interface.

10) The system of claim 7, wherein the mixing tank comprises a level sensor, and wherein the controller is further configured to operate the input pump until a mixing tank level satisfying the mixing profile is reached.

11) The system of claim 1, wherein the heating element is built into the mixing rod.

12) The system of claim 1, further comprising an additive tank and an additive tank pump, and wherein the controller is further configured to operate the additive tank pump to inject additive into the mixing tank according to the mixing profile.

13) The system of claim 1, wherein the main body comprises a platform-contact configured to detect the presence of said reusable bottle and wherein the controller is further configured to receive a bottle's presence signal from the platform-contact and responsively to operate the output pump to convey the mixed solution only when there is a bottle presence signal after a mixing duration elapses as specified by the mixing profile.

14) The system of claim 1, further comprising a bottle platform and said detachable bottle, wherein the platform has a protruding, magnetic contact and the detachable bottle has a cavity configured to couple magnetically with the platform-contact.

15) A method for preparing a mixed detergent solution using a mixing system that includes a mixing tank having a motorized mixing rod and a heater, a capsule receptacle configured to receive a capsule of concentrate, an input pump, an output pump, and a controller having memory with instructions that when executed implement the following steps:
receiving a capsule code from a code reader of the capsule receptacle and responsively determining a mixing profile;
receiving a signal from a level sensor of a water tank indicating that there is sufficient water to prepare a mixed solution;
responsively operating the input pump, pumping water to a capsule in the capsule receptacle and from the capsule receptacle to the mixing tank;
subsequently operating the mixing rod and the heater according to the mixing profile to generate the mixed solution, wherein the mixing profile specifies a duration, temperature and speed of mixing;
subsequently determining that a bottle is in positioned to receive the mixed solution; and
responsively operating the output pump to pump the mixed solution to the detachable bottle.

16) The method of claim 15, further comprising one or more of the following steps:
(i) placing the detachable bottle and receiving a positive-position indication;
(ii) inserting a capsule holding a concentrate into the capsule receptacle;
(iii) opening the capsule; and
(iv) determining a suitable mixing profile.

17) A method for preparing a mixed detergent solution using a mixing system that includes a mixing tank having a motorized mixing rod and a heater, a capsule receptacle configured to receive a capsule of concentrate, an input pump, an output pump, and a controller having memory with instructions that when executed implement the following steps:
placing the detachable bottle and receiving a positive-position indication and determining that a bottle is in positioned to receive the mixed solution;
inserting a capsule holding a concentrate into the capsule receptacle;
receiving a capsule code from a code reader of the capsule receptacle and responsively determining a mixing profile;
receiving a signal from a level sensor of a water tank indicating that there is sufficient water to prepare a mixed solution;
responsively operating the input pump, pumping water to a capsule in the capsule receptacle and from the capsule receptacle to the mixing tank;
subsequently operating the mixing rod and the heater according to the mixing profile to generate the mixed solution, wherein the mixing profile specifies a duration, temperature and speed of mixing; and
responsively operating the output pump to pump the mixed solution to the detachable bottle.

18) The method of claim 15, further comprising a rinsing step.

19) The method of claim 15, wherein the controller is further configured to receive a rinse code of a rinse capsule inserted in the capsule receptacle and responsively to operate the input pump to provide rinse water to the mixing tank and to operate the output pump to complete a rinse process.
